(19) United States
(12) Patent Application Publication
(10) Pub. No.: US 2007/0139491 A1
(43) Pub. Date: Jun. 21, 2007

(54) Fluid storage container

(76) Inventors: John Conway, Louisville, KY (US); Angela Lynn Hudson, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/312,850

(22) Filed: Dec. 20, 2005

(51) Int. Cl. B41J 2/175

(52) U.S. Cl. 347/86

(57) ABSTRACT

A fluid supply cartridge and a method for improving fluid supply characteristics of the fluid supply cartridge. The fluid supply cartridge includes a negative pressure inducing cavity. A negative pressure inducing device is disposed in the cavity. The negative pressure inducing device having a width, a length, and a height. At least one slit is disposed in the negative pressure inducing device transverse to the length and across the width thereof. The at least one slit has a depth that is sufficient to reduce a connection force used to attached the fluid supply cartridge to an ejection head structure.

### FIELD

The disclosure relates to micro-fluid ejection heads, and in particular to improved fluid storage containers for micro-fluid ejection heads.

### BACKGROUND AND SUMMARY

Micro-fluid ejection heads are useful for ejecting a variety of fluids including inks, cooling fluids, pharmaceuticals, lubricants and the like. A widely used micro-fluid ejection head is in an ink jet printer. Ink jet printers continue to be improved as the technology for making the micro-fluid ejection heads continues to advance. New techniques are constantly being developed to provide low cost, highly reliable printers which approach the speed and quality of laser printers. An added benefit of ink jet printers is that color images can be produced at a fraction of the cost of laser printers with as good or better quality than laser printers. All of the foregoing benefits exhibited by ink jet printers have also increased the competitiveness of suppliers to provide comparable printers and supplies for such printers in a more cost efficient manner than their competitors.

Micro-fluid ejection devices may be provided with permanent, semi-permanent, or replaceable ejection heads. Since the ejection heads require unique and relatively costly manufacturing techniques, some ejection devices are provided with permanent or semi-permanent ejection heads. Such ejection heads are connected to removable fluid supply cartridges that that contain the fluid or fluids being ejected. In order to control ejection of the fluids, the cartridges may be provided with a negative pressure inducing device within a fluid cavity of the cartridge. Such negative pressure inducing devices include, but are not limited to, felt blocks, foam blocks, and other porous materials that may be saturated with the fluid and have capillaries or pores that induce a negative pressure in the cavity. The permanent or semi-permanent ejection head may also include a wicking projection that contacts the negative pressure inducing device. However, as described in more detail below, such a projection in combination with a conventional negative pressure inducing device may produce air gaps in the fluid supply cartridge that may result in poor fluid supply performance.

In view of the foregoing, exemplary embodiments of the disclosure provide a fluid supply cartridge and a method for improving fluid supply characteristics of the fluid supply cartridge. The fluid supply cartridge includes a negative pressure inducing cavity. A negative pressure inducing device is disposed in the cavity. The negative pressure inducing device having a width, a length, and a height. At least one slit is disposed in the negative pressure inducing device transverse to the length and across the width thereof. The at least one slit has a depth that is sufficient to regulate and/or stabilize a connection force used to attached the fluid supply cartridge to an ejection head structure.

Another exemplary embodiment of the disclosure provides a method for improving a fluid supply performance of a fluid supply cartridge containing a negative pressure inducing device disposed in the cartridge. The method includes slitting the negative pressure inducing device to provide at least one slit across a width thereof, to a predetermined depth, and in a location of the negative pressure inducing device sufficient to reduce the pore size, and increase the capillary pressure of the negative pressure inducing device adjacent a fluid outlet wick. The negative pressure inducing device is disposed in a cavity of the fluid supply cartridge so that the at least one slit is adjacent an outlet port of the fluid supply cartridge.

### BRIEF DESCRIPTION OF THE DRAWINGS

Further features and advantages of the disclosed embodiments may become apparent by reference to the detailed description when considered in conjunction with the figures, which are not to scale, wherein like reference numbers indicate like elements through the several views, and wherein:

FIG. 1 is a top perspective view, not to scale, of a fluid supply cartridge and cover therefore;

FIG. 2 is a bottom perspective view, not to scale, of a fluid supply cartridge and fluid outlet port therein;

FIG. 3 is a cross-sectional view, not to scale, of a fluid supply cartridge containing a negative pressure inducing device therein and a portion of a micro-fluid ejection head structure for connection to the fluid supply cartridge;

FIG. 4 is a cross-sectional view, not to scale, of a fluid supply cartridge connected to a micro-fluid ejection head structure, the fluid supply cartridge containing a negative pressure inducing device therein;

FIG. 5 is a top perspective view, not to scale, of a negative pressure inducing device according to one embodiment of the disclosure;

FIG. 6 is a bottom perspective view, not to scale, of the negative pressure inducing device of FIG. 5;

FIG. 7 is a cross-sectional view, not to scale, of a fluid supply cartridge connected to a micro-fluid ejection head structure, the fluid supply cartridge containing the negative pressure inducing device of FIG. 5; and

FIGS. 8 and 9 are graphical representations of connecting forces versus deflections for a prior art negative pressure inducing device and a negative pressure inducing device according to an embodiment of the disclosure.

### DETAILED DESCRIPTION OF THE PREFERRED EMBODIMENTS

For the purposes of this disclosure, a wide variety of negative pressure inducing devices may be used provided the device is in intimate contact with a fluid outlet wick when a fluid supply cartridge is attached to a micro-fluid ejection head structure. Such negative pressure inducing devices include, but are not limited to, open cell foams, capillary containing materials, absorbent materials, and the like.

As used herein, the terms “foam” and “felt” will be understood to refer generally to reticulated or open cell foams having interconnected void spaces, i.e., porosity and permeability, of desired configuration which enable a fluid to be retained within the foam or felt and to flow therethrough at a desired rate for delivery to a micro-fluid ejection head. Foams and felts of this type are well known in the art. A commercially available example of a suitable foam is a felted open cell foam which is a polyurethane material made by the polymerization of a polyol and toluene diisocyanate. The resulting foam is a compressed, reticulated flexible polyester foam made by compressing a foam with both pressure and heat to specified thickness.

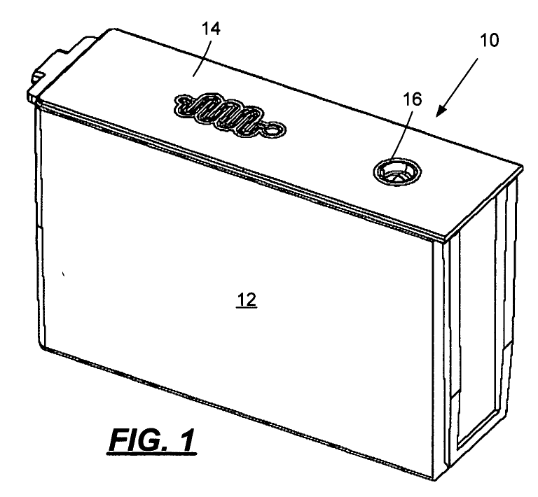

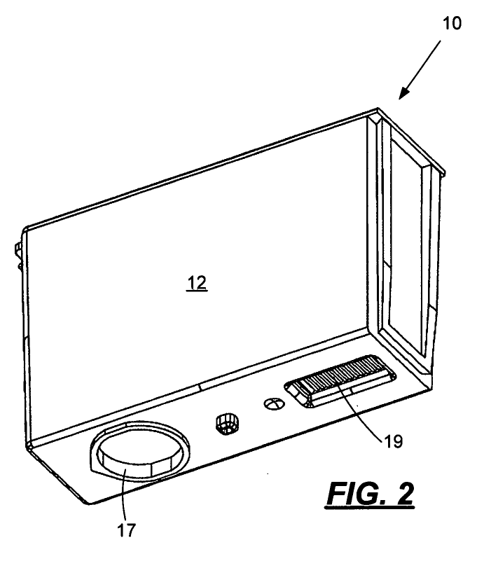

With reference to FIGS. 1 and 2, perspective views of a fluid reservoir 10 are illustrated. The fluid reservoir 10 includes a rigid body 12 and a cover 14 attached to the body 12. The cover 14 may include an inlet port for 16 for filling or refilling the body 12 with fluid such as ink.

A bottom perspective view of the fluid reservoir 10 is provided in FIG. 2. A fluid outlet port 17 is provided for flow of fluid out of the fluid reservoir 10 to a micro-fluid ejection head structure described in more detail below. The fluid reservoir 10 may also include a substantially transparent panel 19 for detecting a liquid level in the fluid reservoir 10.

The rigid body 12 and cover 14 may be made of a variety of materials including, but not limited to, metals, plastics, ceramics, and the like, provided they are made of materials compatible with the fluids they contain. In that regard, a polymeric material that may be used to provide the body 12 and cover 14 may be selected from the group consisting of an amorphous thermoplastic polyetherimide available from G.E. Plastics of Huntersville, N.C., a glass filled thermoplastic polyethylene terephthalate resin available from E. I. du Pont de Nemours and Company of Wilmington, Del., a syndiotactic polystyrene containing glass fiber available from Dow Chemical Company of Midland, Mich., a polyphenylene oxide/high impact polystyrene resin blend available from G.E. Plastics, and a polyamide/polyphenylene ether resin available from G.E. Plastics.

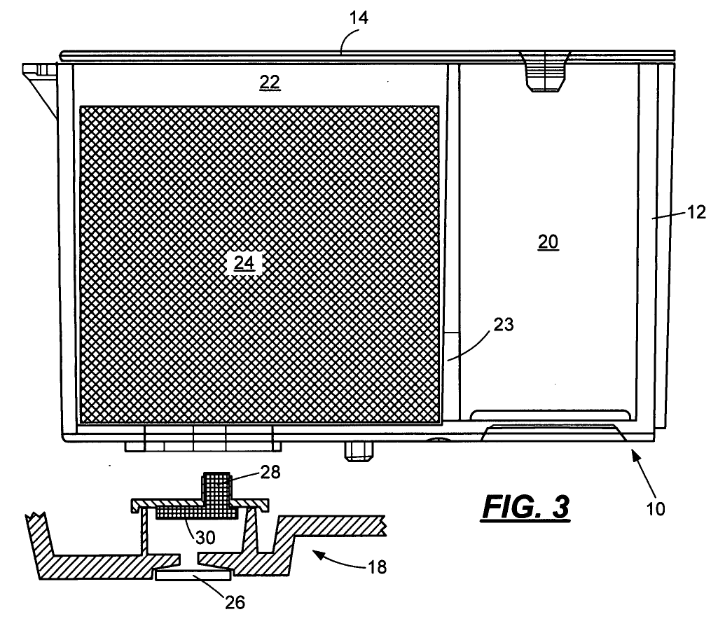

A cross-sectional view of the fluid reservoir 10 and an ejection head structure 18 are illustrated in FIG. 3. As shown, the fluid reservoir 10 includes a liquid compartment 20, a negative pressure inducing cavity 22, and a fluid flow opening 23 connecting the liquid compartment 20 with the negative pressure inducing cavity 22. The negative pressure inducing cavity 22 contains a negative pressure inducing device 24 such as a felted foam, described above. When the fluid reservoir 10 is operatively connected in fluid flow communication with the ejection head structure 18, fluid from the negative pressure inducing cavity 22 is caused to flow into the ejection head structure 18 for controlled ejection of fluid, such as ink, onto a fluid receptive media. In that regard, the ejection head structure includes a micro-fluid ejection head 26 attached thereto. A wick/filter structure 28/30 provides contact with the negative pressure inducing device 24 when the fluid reservoir 10 is attached to the ejection head structure 18. Intimate contact between the wick 28 and the negative pressure inducing device 24 allows fluid to flow to the ejection head structure 18 from the fluid reservoir 10.

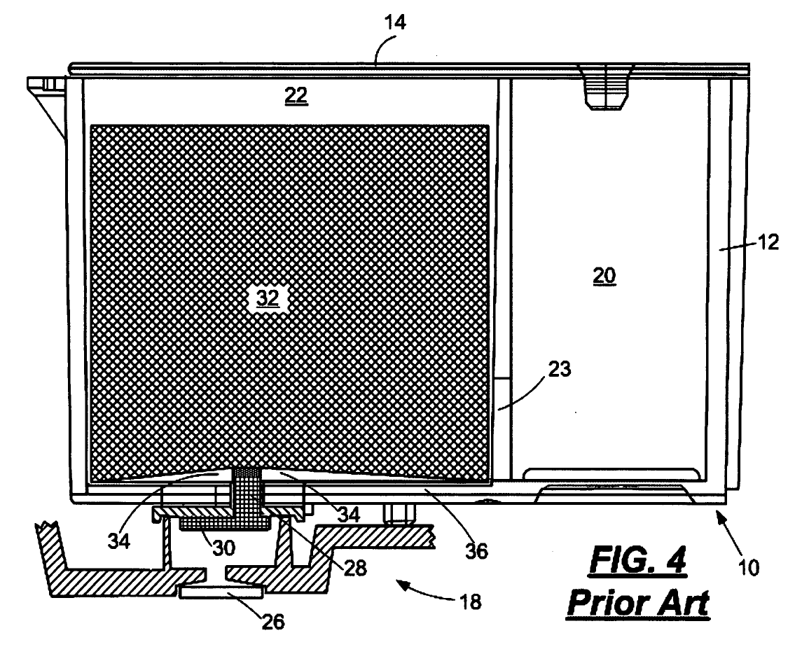

However, as shown in FIG. 4, when a typical negative pressure inducing device, such as device 32, is attached to the ejection head structure 18, interference contact between the device 32 and wick 28 may cause undue compression of the felt 32 and the formation of air gaps 34 between the device 32 and an fluid outlet wall 36 of the fluid reservoir 10. The gaps 34 may cause fluid to leak or drool from the reservoir 10.

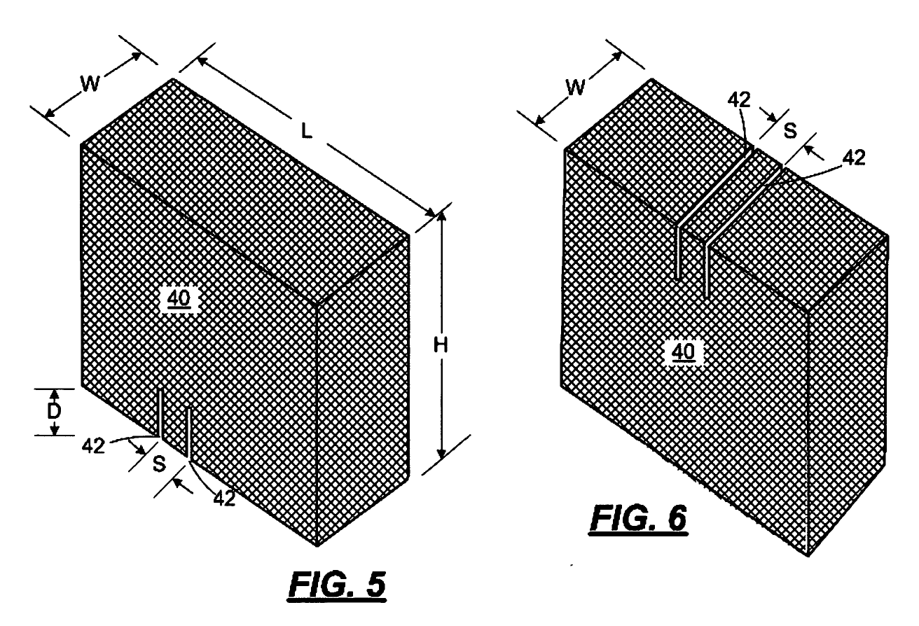

In order to improve the fluid flow characteristics between the negative pressure inducing device 24 and the ejection head structure 18, an improved negative pressure inducing device, such as device 40 (FIGS. 5 and 6) is provided. The device 40 has a length L, a width W and a height H, and includes at least one slit 42 therein, or alternatively, two slits 42 therein that are disposed transverse to the length L. The slit or slits 42 are typically made across the width W of the device 40 to a depth D that is less than the height H of the device 40. As shown in FIGS. 5 and 6, two spaced- apart slits 42 are provided. The spacing between the slits 42 is typically the same as or slightly greater than a width or diameter dimension of the wick 28. The depth D of the slits 42 may range from about 3 to about 10 millimeters, with about 6 millimeters in depth D being typical. As described in more detail below, variations in the depth of the slits 42 may be used to select a desired connection force for a supply cartridge 10 to an ejection head structure 18.

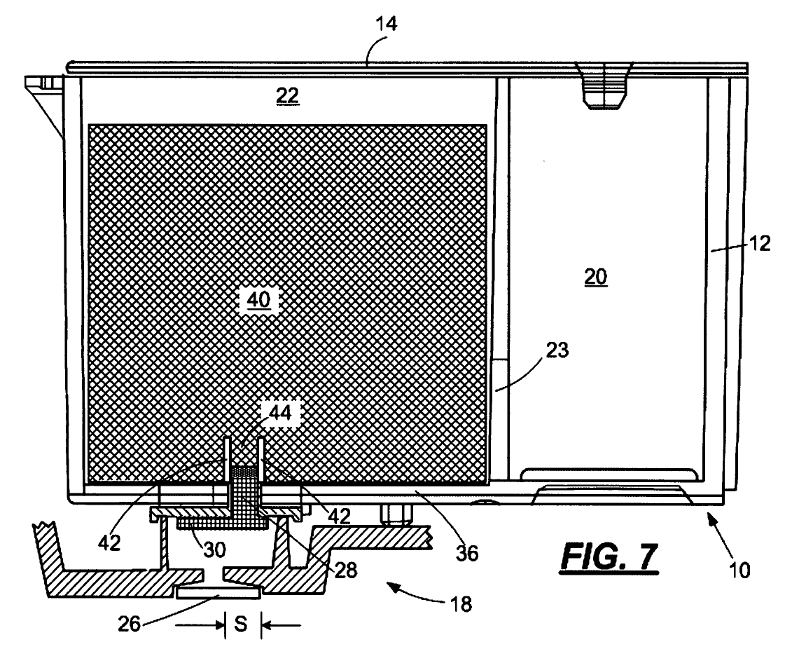

With reference now to FIG. 7, the slits 42 may be effective to locally control the compression of the felt 32 and enable the negative pressure inducing device 40 to remain adjacent to the outlet wall 36 of the reservoir 10 thereby substantially eliminating the air gaps 34 formed with the prior art negative pressure inducing device 32. While not desiring to be bound by theory, it is believed that the slits 42 provide pressure relief for the area between the slits 42 having the width S and length D (FIG. 5). This area (S X D) is substantially less than an area (W X L) provided by the prior are negative pressure inducing device 32 illustrated in FIG. 4. Because the area of the device 40 adjacent the wick 28 is reduced by the pressure relief slits 42, a permanent indentation of the device 40 is bounded and/or localized between slits 42 so that the rest of device 40 contacts the bottom wall.

An advantage of at least some of the embodiments described herein is that a zone of compression of the negative pressure inducing device 40 is directly over the wick 28 thereby providing enhanced fluid flow characteristics between the negative pressure inducing device 40 and the wick 28. Remaining areas of the negative pressure inducing device 40 are substantially uncompressed and thus remain adjacent to the outlet wall 36 of the cartridge 10.

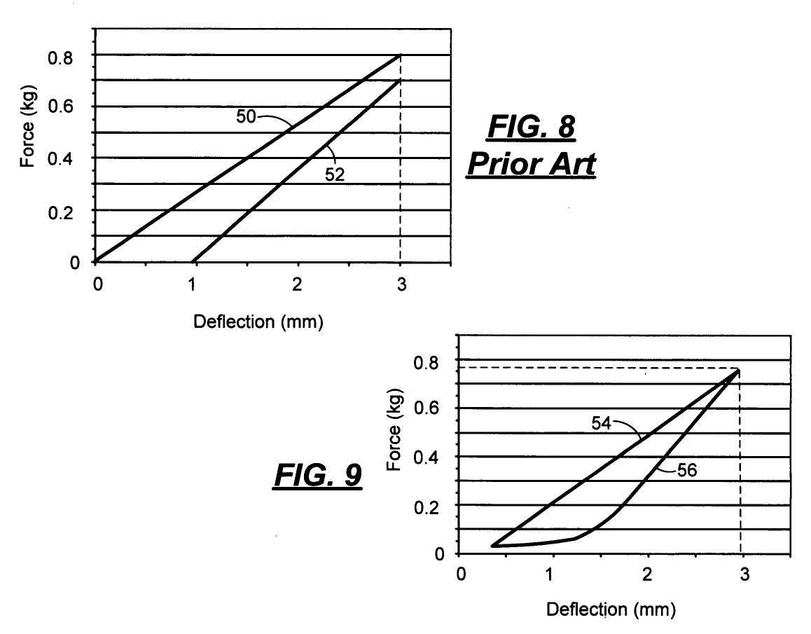

Graphical representations of connection forces versus deflection of the wick 28 and/or devices 32 and 40 are illustrated in FIGS. 8 and 9. In FIG. 8, curve 50 represents a relationship between a connection force for a desired deflection when the fluid supply cartridge 10 containing the prior art negative pressure inducing device 32 is initially attached to the micro-fluid ejection head structure 18. Curve 52 represents a relationship between a connection force for a desired deflection when the cartridge 10 is repeatedly attached to the ejection head structure 18. The divergence illustrated at a deflection of 3 millimeters indicates that somewhat permanent deformation of the wick 28 and/or device 32 has occurred. Hence, less force is required for subsequent connection of the cartridge 10 to the structure 18 after the initial connection between the two.

By contrast, FIG. 9 represents connection forces versus deflection when the cartridge contains the device 40 including the slits 42. As in FIG. 8, curve 54 represents a relationship between a connection force for a desired deflection when the fluid supply cartridge 10 containing the negative pressure inducing device 40 is initially attached to the micro-fluid ejection head structure 18. Curve 56 represents a relationship between a connection force for a desired deflection when the cartridge 10 is repeatedly attached to the ejection head structure 18. Because of the slits 42 in the device 40, there is substantially less permanent deformation of the wick 28 and/or device 40 so that the connection force required at about a 3 millimeter deflection is about the same regardless of how many times the cartridge 10 is connected to the structure 18. Variation is the depth D of the slits 42 may be used to select a desired connection force for a given deflection, and/or may be used to reduce the deflection for a predetermined connection force.

Having described various aspects and embodiments of the disclosure and several advantages thereof, it will be recognized by those of ordinary skills that the embodiments are susceptible to various modifications, substitutions and revisions within the spirit and scope of the appended claims.

What is claimed is:

1. A fluid supply cartridge comprising a negative pressure inducing cavity and a negative pressure inducing device disposed in the cavity, the negative pressure inducing device having a width, a length, and a height and comprising at least one slit disposed therein transverse to the length and across the width thereof, wherein the at least one slit has a depth that is sufficient to regulate a connection force used to attached the fluid supply cartridge to an ejection head structure.

2. The fluid supply cartridge of claim 1, wherein the negative pressure inducing device includes two spaced-apart slits.

3. The fluid supply cartridge of claim 1, wherein the negative pressure inducing device comprises a porous felt or foam material.

4. The fluid supply cartridge of claim 1, wherein the at least one slit has a depth ranging from about 3 to about 10 millimeters.

5. The fluid supply cartridge of claim 1, wherein the at least one slit is effective to substantially eliminate gaps between the negative pressure inducing device and a fluid outlet wall of the cavity.

6. A method for improving a fluid supply performance of a fluid supply cartridge containing a negative pressure inducing device disposed in the cartridge, the method comprising the steps of:
slitting the negative pressure inducing device to provide at least one slit across a width thereof, to a predetermined depth and in a location of the negative pressure inducing device sufficient to regulate a pressure of the negative pressure inducing device adjacent a fluid outlet wick, and
disposing the negative pressure inducing device in a cavity of the fluid supply cartridge so that the at least one slit is adjacent an outlet port of the fluid supply cartridge.

7. The method of claim 6, wherein the step of slitting comprises providing a plurality of spaced-apart slits in the negative pressure inducing device.

8. The method of claim 6, wherein the negative pressure inducing device comprises a porous felt or foam material.

9. The method of claim 6, wherein the predetermined depth ranges from about 3 to about 10 millimeters.

10. The method of claim 6, wherein the at least one slit is effective to substantially eliminate gaps between the negative pressure inducing device and a fluid outlet wall of the cavity.

11. A method for selecting a predetermined connection force required to connect a fluid supply cartridge to a micro-fluid ejection head structure, the method comprising:
slitting a negative pressure inducing device to provide at least one slit across a width and to a depth in the negative pressure inducing device, wherein the at least one slit has a depth ranging from about 3 to about 10 millimeters; and
inserting the negative pressure inducing device containing the at least one slit in a fluid supply cartridge so that the at least one slit is effective to regulate a pressure of the device adjacent a fluid supply wick of the micro-fluid ejection head structure.

12. The method of claim 11, wherein the step of slitting comprises providing two or more spaced-apart slits in the negative pressure inducing device.

13. The method of claim 12, wherein the two spaced-apart slits are spaced-apart an amount greater than or equal to the diameter of the wick.

14. The method of claim 11, wherein the negative pressure inducing device comprises a porous felt or foam material.

15. The method of claim 11, wherein the at least one slit is effective to substantially eliminate gaps between the negative pressure inducing device and a fluid outlet wall of the fluid supply cartridge.
